(19) United States
(12) Patent Application Publication
(10) Pub. No.: US 2017/0294083 A1
(43) Pub. Date: Oct. 12, 2017

(54) Card Game To Play Along With An Event Having Activities

(71) Applicant: Jacquelyn Finn, Milwaukee, WI (US)

(72) Inventor: Jacquelyn Finn, Milwaukee, WI (US)

(21) Appl. No.: 15/093,154

(22) Filed: Apr. 7, 2016

(51) Int. Cl. G07F 17/32; A63F 1/00

(52) U.S. Cl. CPC G07F 17/3288; A63F 1/00; G07F 17/3293; G07F 17/3276; G07F 17/3211; G07F 17/3244

(57) ABSTRACT

A card game includes a plurality of game cards. Each game card identifies an activity that can occur during an event being watched. The card game can be played by assigning the game cards to each player. A player wins upon a first occurrence of an activity identified on one of the game cards by a player assigned to the one of the game cards identifying the first occurring activity. If play cards are used, a player selects a play card identifying a point during the event after which the game begins. If turn cards are used, a player receives one or more turn cards identifying an order in which a player may select a game card for assignment to the player.

### CROSS-REFERENCE TO RELATED APPLICATIONS

Not Applicable.

### STATEMENT REGARDING FEDERALLY SPONSORED RESEARCH OR DEVELOPMENT

Not applicable.

### FIELD OF THE INVENTION

The present invention relates to card games, and more specifically to a sports wagering card game which is particularly suitable for friends and families to play together while watching a sporting event.

### BACKGROUND OF THE INVENTION

Sports wagering is a popular spectator sport in the U.S., if not the entire world. The popularity of sports wagering has extended itself into casinos and bars across the country, and perhaps more casually in the comfort of one's home or other locations removed from the sport's field. Families and friends who love watching the “big game” always have someone who does not enjoy it as much as they, and are constantly looking for a way to peak their interest, and so this invention creates a closer bonding and excitement between all people involved.

### BRIEF SUMMARY OF THE INVENTION

One embodiment of the present invention is a card game including a plurality of game cards, each game card identifying an activity that can occur during an event being watched. In another embodiment, the card includes a plurality of play cards, each play card when selected determines a point during the event after which an activity identified by a game card qualifies a player to collect a prize. In yet another embodiment, the card game includes a plurality of turn cards, each turn card when revealed indicates an order in which a player may select a game card.

The card game can be played by assigning game cards to each player. The players agree upon a prize to be awarded upon a first occurrence of an activity identified on one of the game cards. The players then watch an event for the activities identified on the game cards. A prize is collected upon a first occurrence of an activity identified on one of the game cards by a player assigned to the one of the game cards identifying the first occurring activity. If play cards are used, a player selects a play card identifying a point during the event after which a first occurrence of an activity identified on one of the game cards qualifies the player to collect the prize upon a first occurrence of an activity identified on one of the game cards. If turn cards are used, a player receives one or more turn cards identifying an order in which a player may select a game card for assignment to the player.

### BRIEF DESCRIPTION OF THE DRAWINGS

The drawings provided represent the instruction booklet and playing cards that comprise this game.

FIG. 1 depicts the instruction booklet, which folds accordion style, and is split in half for ease of view in this document;

FIG. 2a shows a game card depicting a Strike Out at one end and a Quarterback Tackle/Sack/Safety at another end;

FIG. 2b shows a game card depicting a Triple at one end and a QB Hand-Off at another end;

FIG. 2c shows a game card depicting a Home Run at one end and a QB Pitch Out at another end;

FIG. 2d shows a game card depicting a Sacrifice at one end and an Interception another end;

FIG. 2e shows a game card depicting a Double at one end and a QB Run at another end;

FIG. 2f shows a game card depicting a Single at one end and a QB Pass/Flea Flicker at another end;

FIG. 2g shows a game card depicting a Walk/Hit By Pitch at one end and a Punt/Field Goal at another end;

FIG. 2h shows a game card depicting a Ground-Out at one end and a Touchdown at another end;

FIG. 2i shows a game card depicting a Fly-out at one end and an Incomplete Pass at another end;

FIG. 2j shows a game card depicting an Error at one end and a Delay Of Game/Take A Knee at another end;

FIG. 2k shows a game card back;

FIGS. 3a-3d depict play cards; and

FIGS. 4a-4f depict turn cards;

FIG. 5 depicts a sample layout of the cards on a game table; and

FIG. 6 depicts the sample layout of FIG. 5 with turn cards.

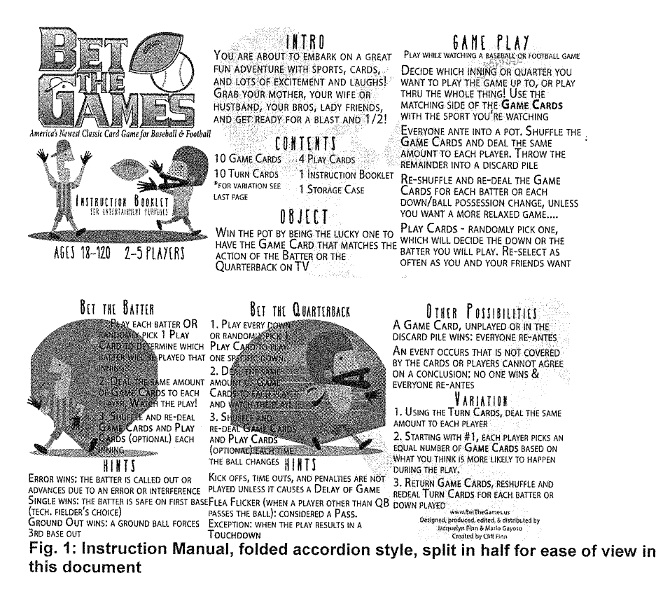

### DETAILED DESCRIPTION OF THE INVENTION

The images referred to herein are for the purposes of the specific aspects of the present invention and are not meant to limit the scope of the present invention. For example, the present invention is described with respect to baseball and football, but may also be expanded to any event having specific identifiable activities and other sports including but not limited to basketball, hockey, soccer, and golf. Cards described herein are applicable to both baseball and football, but the cards can be provided for only football or only baseball without departing from the scope of the claims.

An embodiment of the present invention is a card game where indicia of playing cards are displayed to two up to ten players. As used herein, the phrase “indicia of playing cards” is meant to include actual playing cards, as well as images of playing cards displayed either mechanically, electro-mechanically, electronically, or otherwise. For example, it is well within the scope of the present invention to display indicia of playing cards on a board game, on a mechanical slot machine, on an electronic gaming device, on another video screen, or utilizing another form of image generation such as holography.

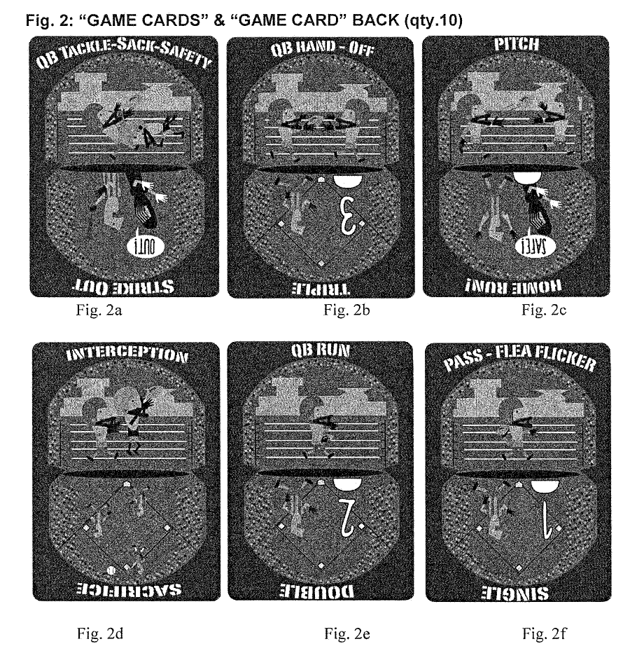

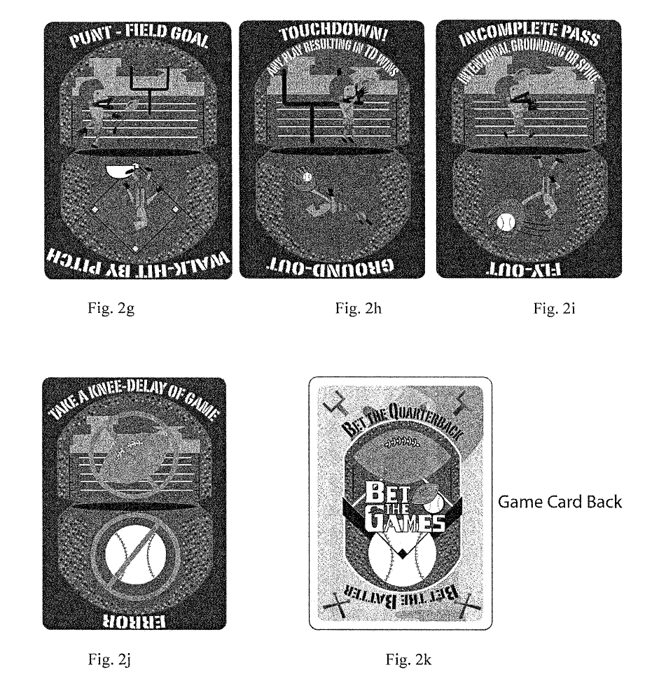

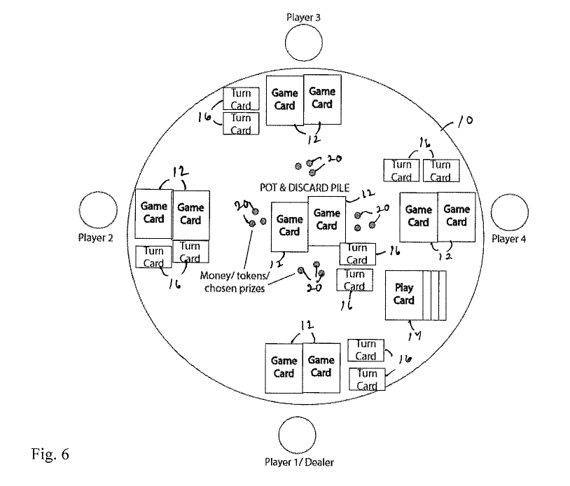

A preferred embodiment of the card game includes cards used by players while watching an event, such as a football game or a baseball game. As shown in FIGS. 5 and 6, the card game can be played at a table 10 and includes game cards 12, such as shown in FIGS. 2a-2k. In the embodiment described herein, each game card 12 has one end depicting an activity that can occur during a baseball game, and another end depicting an activity that can occur during a football game. For example, FIG. 2a depicts a strike-out for baseball at one end of the game card and a QB Tackle/Sack/Safety for football at the other end of the game card.

Each player is assigned one or more game cards 12 randomly or by selecting game cards in a predetermined order. Upon assignment of all or a predetermined number of game cards, the players watch the event for activities during the event that correspond with activities depicted on the game cards. If the activity depicted on an assigned game card occurs during the event, the player assigned the game card may be eligible for a prize.

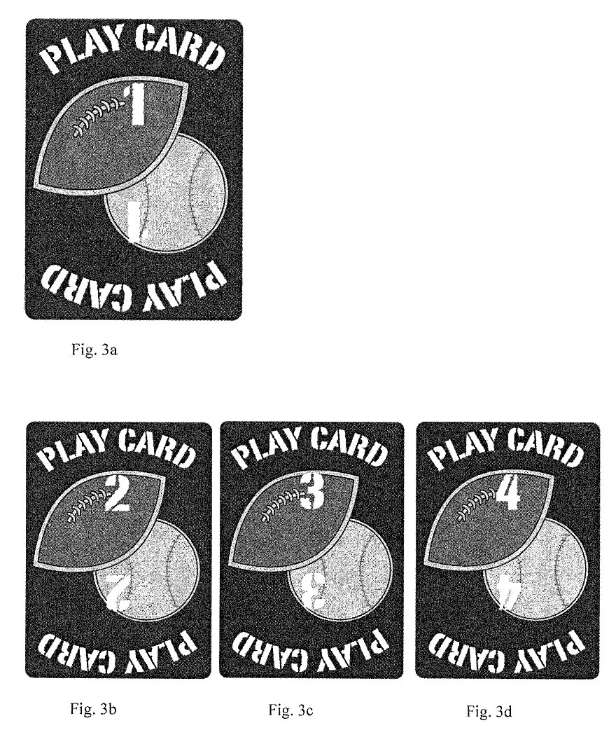

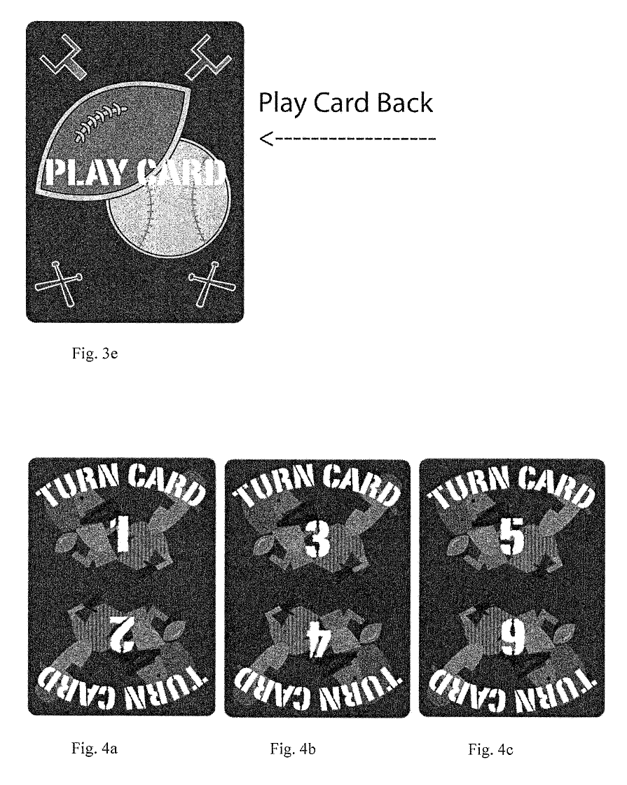

Play cards 14, such as shown in Figs. FIG. 3a-3e can be provided to determine when an activity must occur in order for the player to be eligible for a prize 20. In the embodiment described herein, each play card 14 includes a number representing a down or batter that must begin or be up to bat during which the card game will be played. In other embodiments, the play card 14 can depict any point or period during the event after which the game is played.

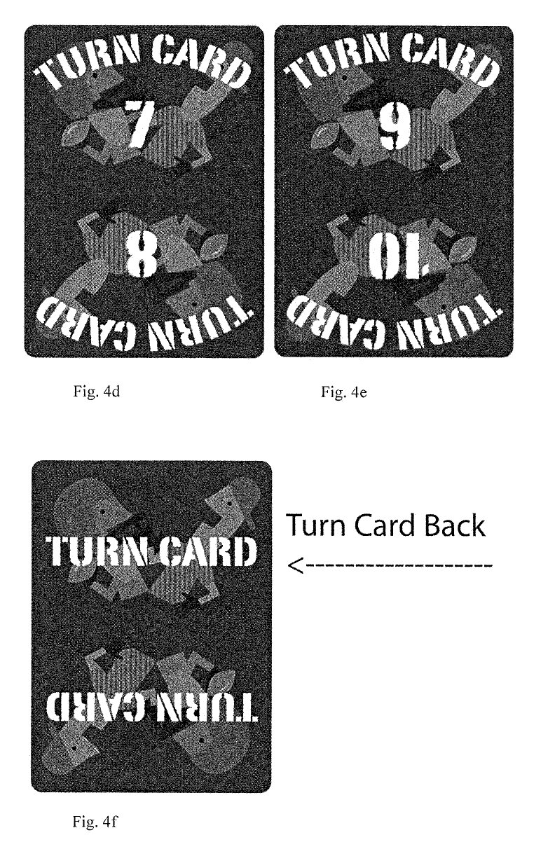

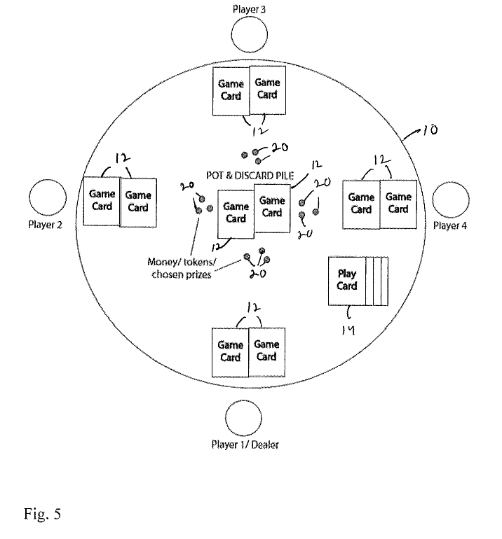

Turn cards 16, such as shown in Figs. FIG. 4a-4f can be provided to determine an order in which players can select game cards 12. In the embodiment described herein, the turn cards 16 are numbered cards that dictate the order of which the players may choose game cards. Advantageously, determining an order of which players select game cards 12 allows the players to select the game cards 12 based on their own strategy and knowledge of the event being watched.

The players may set up the game in whatever comfortable setting they choose. The game is played in a number of rounds as the sporting game being watched advances. In each round, each player is playing against every other player for the prize 20, such as an “Ante” or wagers collected in a common “pot”.

In one embodiment of the game, at the commencement of the game, players turn on/watch a baseball game or American football game and use the corresponding end of the game cards 12.

The players decide together up to what point in the sporting game they will play the card game, if they will utilize the play cards 14, if they will utilize the turn cards 16, and what their prize 20 will be.

If an Ante is selected as the prize 20, the players then place their wagers in the pot.

One play card 14 is either deliberately chosen or chosen randomly, and may be changed whenever the players decide to choose a different one. If the event is football or baseball, the play card 14 determines the batter or the down that will be played. The game cards 12 are dealt out, an equal number to each player and extras are discarded. If utilizing the turn cards 16, the turn cards 16 are dealt out instead of the game cards 12, an equal number to each player, discarding any extras, and starting with number one, each player chooses game cards based on what they strategically think is likely to happen that play. Remaining game cards 12 are discarded.

The sporting game is watched and the outcome of the play—in regards to the quarterback or the batter—should match one of the game cards 12, and the player with that matching game card 12 wins the prize 20 or wagers in the pot.

Once the prize 20 is claimed, game cards 12 and/or turn cards 16 are re-shuffled and re-dealt for each batter or each down/ball possession change, unless using the play cards 14 in which case the game cards 12 and/or turn cards 16 are re-shuffled and re-dealt only for that chosen batter or down. Before each round of the card game, players re-Ante their wager or chosen prize 20 into the pot.

The activity depicted on individual game cards match the activity in the event. For example for baseball, the “Error” “game card shown in FIG. 2j is a match when the batter is called out or advances due to an error or interference. The “Single” game card shown in FIG. 2f matches when the batter is safe on first base even if a fielder's choice. The “Ground Out” game card shown in FIG. 2h matches when a ground ball forces third base out.

Special rules can be applied for specific activities. For example, in football, kick offs, time outs, and penalties are not played unless it causes a delay of game (FIG. 2j) in which case the Delay of Game game card shown in FIG. 2j applies. A flea flicker shown in FIG. 2f is considered a pass except when the play results in a touchdown when the game card shown in FIG. 2h applies. Finally, if a game card 12 matching an occurrence depicted on the game card is in the discard pile, everyone re-antes, and when an event occurs that is not covered by the game cards, or the players cannot agree on occurrence of an activity, no one wins and everyone re-antes.

What is claimed is:

1. A card game played while watching an event, said game comprising;
a plurality of game cards, each game card identifying an activity that can occur during an event being watched.

2. The card game of claim 1 including a plurality of play cards, each play card when selected determines a point during the event after which an activity identified by a game card qualifies a player to collect a prize.

3. The card game of claim 1 including a plurality of turn cards, each turn card when revealed indicates an order in which a player may select a game card.

2. The card game of claim 1, in which each card is displayed electronically.

3. The card game of claim 1 including an instruction booklet providing rules of the game.

4. The card game of claim 1, in which said event is football or baseball, and at least one of said game cards identifies an activity specific to football or baseball.

5. The card game of claim 1, in which at least one of said game cards identifies two different activities, each of said two different activities being specific to a different event.

7. A method of playing a game, said method comprising:
assigning game cards to each player; each of said game cards identifying an activity that can occur during an event being watched;
agreeing upon a prize to be awarded upon a first occurrence of an activity identified on one of said game cards;
watching the event for the activities identified on said game cards; and
collecting said prize upon a first occurrence of an activity identified on one of said game cards by a player assigned to said one of said game cards identifying the first occurring activity.

8. The method as in claim 6, in which a player selects a play card identifying a point during the event after which a first occurrence of an activity identified on one of said game cards qualifies the player to collect said prize upon a first occurrence of an activity identified on one of said game cards. The method of claim 6, in which a player receives at least one turn card identifying an order in which a player may select a game card for assignment to the player.

10. The method of claim 6, in which said game cards are displayed electronically.

11. The method of claim 6, in which said event is football or baseball, and at least one of said game cards identifies an activity specific to football or baseball.

12. The method of claim 6, in which at least one of said game cards identifies two different activities, each of said two different activities being specific to a different event.
